(19) United States
(12) Patent Application Publication
(10) Pub. No.: US 2005/0240662 A1
(43) Pub. Date: Oct. 27, 2005

(54) Identifying, cataloging and retrieving web pages that use client-side scripting and/or web forms by a search engine robot

(76) Inventor: Jason Wiener, Chicago, IL (US)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 10/982,389

(22) Filed: Nov. 5, 2004

Related U.S. Application Data
(60) Provisional application No. 60/517,480, filed on Nov. 5, 2003.

(51) Int. Cl. G06F 15/16; G06F 15/173

(52) U.S. Cl. 709/219; 709/225

(57) ABSTRACT

The purpose of the invention is to enable a search engine spider to build an index of web pages from a particular web site that utilizes forms and/or client-side scripting.

### CROSS REFERENCE TO RELATED APPLICATIONS

This application claims benefit to provisional application 60/517,480 filed on Nov. 5, 2003.

### FIELD OF THE INVENTION

The present invention relates generally to the retrieval, identification and storage of web pages. More particularly the invention relates to web pages that are customized and delivered to users based on a user's request and, on occasion but not necessarily always, that are generated using information stored in a database.

### DESCRIPTION OF RELATED ART

The World Wide Web (“web”) contains a vast amount of information not currently accessible by search engines because the applications used by search engine cannot understand and consequently ignore pages utilizing web forms to customize documents returned for a user's request. Many web forms utilize client-side scripting (such as but not limited to javascript) to customize a returned web page's content and web form options based upon the users choices during interaction with the page.

A web “crawl” consists of retrieving pages from a desired web server, cataloging hyperlink references and web form options from each page retrieved and adding these items to a queue for retrieval. Once the queue has been exhausted, the crawl has been completed. Unfortunately, when prior art crawlers come across script references embedded in the web page, the crawlers ignore the scripts. As such, information contained in and information generated by the scripts are not retrieved or reposed. Moreover, when the scripts are used to populate and customize forms the possible permutations associated with attempting to retrieve each unique page, may be infinite. Similarly, since prior art crawlers do not catalog or repose the permutations and retrieve the other pages, only a small amount of a target web site's documents are cataloged and reposed.

### SUMMARY OF THE INVENTION

The purpose of the invention is to enable a search engine spider (otherwise known as a spider or bot) to build a collection of web pages from a particular web site that utilizes client-side scripting and/or forms and form elements. Scripts and forms are used to generate customized web pages and material specific content. Scripts and forms more efficiently deploy content without the need for publishing individual static documents for each piece of content/information available on a web site. Web pages with forms are customized based on user choices on a form submission page and typically have a finite number of permutations associated with each option. The invention identifies the scripts options utilized on a web page on a particular web site, queues the options and references to a database for retrieval and then systematically retrieves the document with all possible permutations available.

In one embodiment of the invention a computer-implemented method is provided for performing a crawl of a target web page that contains at least one reference to include a script document stored in an alternate location (i.e. another web [symbol] intranet server, etc). For each reference included in the target web page, the [symbol] retrieve and include the source code from the referenced file into the target [symbol] retrieved. Once all referenced files have been retrieved and included into the target web page being crawled, the aggregate page may be further analyzed by the bot.

The web page and/or the aggregate web page may include forms, the bot evaluates the forms, and builds a virtual execution model for each of the form elements contained within the page. Using the virtual execution model, the bot then queues all possibilities and permutations of web form options for the page for the continuation of the crawl and retrieves the information referenced by the form elements.

### BRIEF DESCRIPTION OF THE DRAWINGS

The accompanying drawings incorporated in and constitute part of this specification, illustrate an embodiment of the invention and, together with the description, explain the invention. In the drawings,

FIG. 1 is a diagram illustrating an exemplary system in which concepts consistent with the present invention may be implemented;

FIG. 2 is a flow chart illustrating an exemplary system in which the crawler application retrieves script references and uses the script references to obtain an aggregate web page;

FIG. 3 is a flow chart illustrating an exemplary system in which the crawler retrieves script references and form elements;

FIG. 4 is a flow chart illustrating methods consistent with the present invention for cataloging web pages that utilize form-base client-side scripting from a target web site;

FIG. 5 is a flow chart illustrating, in additional detail, methods consistent with the present invention for cataloging elements on web pages that utilize form-based client-side scripting from a target web site;

FIG. 6 is a flow chart illustrating a method for retrieving and storing web pages that utilize form-based client-side scripting from a target web site; and

FIG. 7 is a hierarchical diagram illustrating the priority of execution of objects on web pages that utilize form-based client-side scripting from a target web site.

### DETAILED DESCRIPTION

Overview

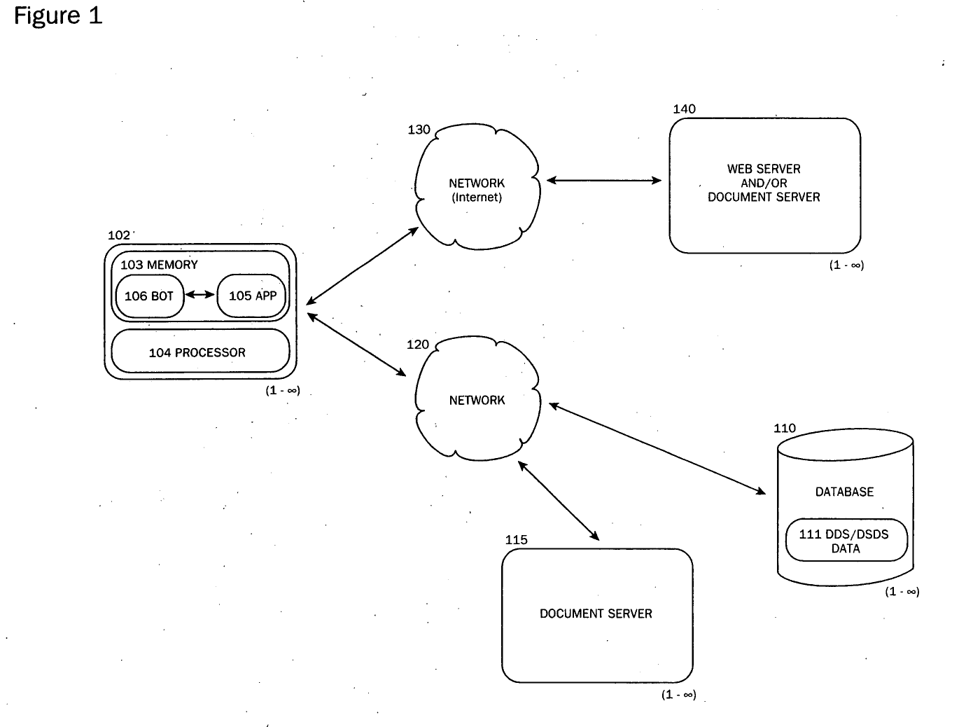

A generalized computer network diagram, consistent with the present invention is illustrated in FIG. 1. The invention consists of an application 105, written in a computer-readable language, executed in memory 103 on any number of computers or servers 102 that are used in conjunction with search engine crawling practices. The application 105 is therefore a search engine used in connection with a crawler, spider, or bot 106 in accordance with the present invention discussed in greater detail below. The application/bot is performed on a computer 102 that may be logically connected to a private local area network 120 containing any number of document servers 115 and/or database servers 110. The computers 102 are logically connected to a network 130 (such as the Internet) containing any number of document servers 140. FIG. 1 illustrates the invention as being executed in memory 103 in conjunction with the computer 102 running the search engine bot 106. The computer 102 can, but isn't required to, run the search engine bot application 106 locally. In cases where the bot 106 is not executed locally, the invention application 105 can be accessed over the network 120. Within the database servers 110, script references, web page form value and variable permutations (collectively referred to as details 111) specific to the target web page and that will be used by the bot and/or application are stored 111. These details 111 may be stored in database applications including (but not limited to) MySQL, Oracle, Microsoft SQL Server or Filemaker Pro or as documents formatted as (but not limited to) text, XML or HTML.

Operation

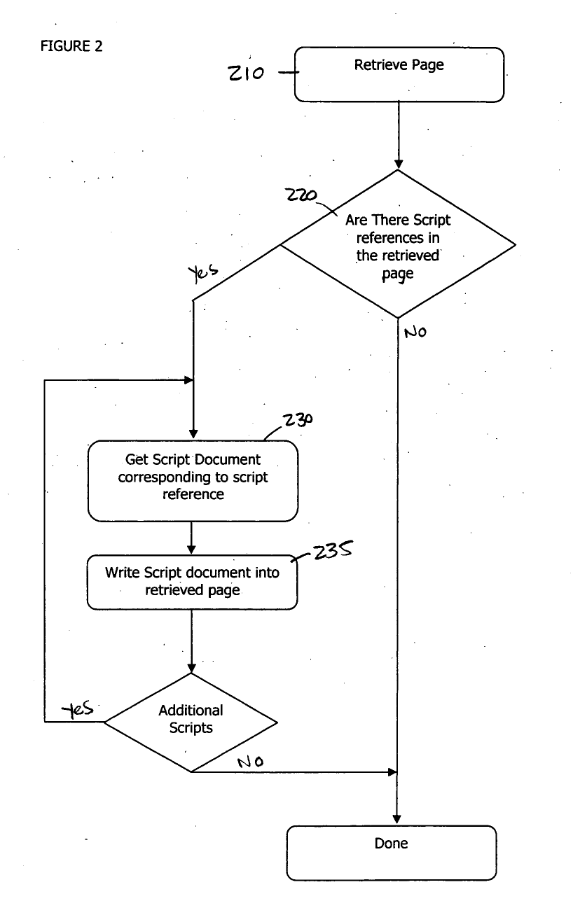

Referring now to FIG. 2, in the first aspect of the invention, a bot crawls a web page on a target web site to catalog and index the page for use by the search engine. In Step 210 the target web page is retrieved by the bot 105. After the requested page is returned, the retrieved page is analyzed to identify if the retrieved page contains references to script documents (referred to as script references), Step 220. As mentioned, the script references are used in a web page in order to direct the web server to retrieve and aggregate secondary documents pointed to by the script references in the web page. If the retrieved page includes script references, all script documents corresponding to the script references are retrieved, Step 230. The script documents are aggregated or written into the retrieved page, Step 235. The aggregated retrieved page is then cataloged and indexed. This is a major improvement over prior art search engine crawlers because documents incorporating client-side scripting are now capable of being comprehensively crawled. In addition to the above, the method may further store and catalog the script references onto the database 110 for future utilization when the bot returns to update the index on the target web-page.

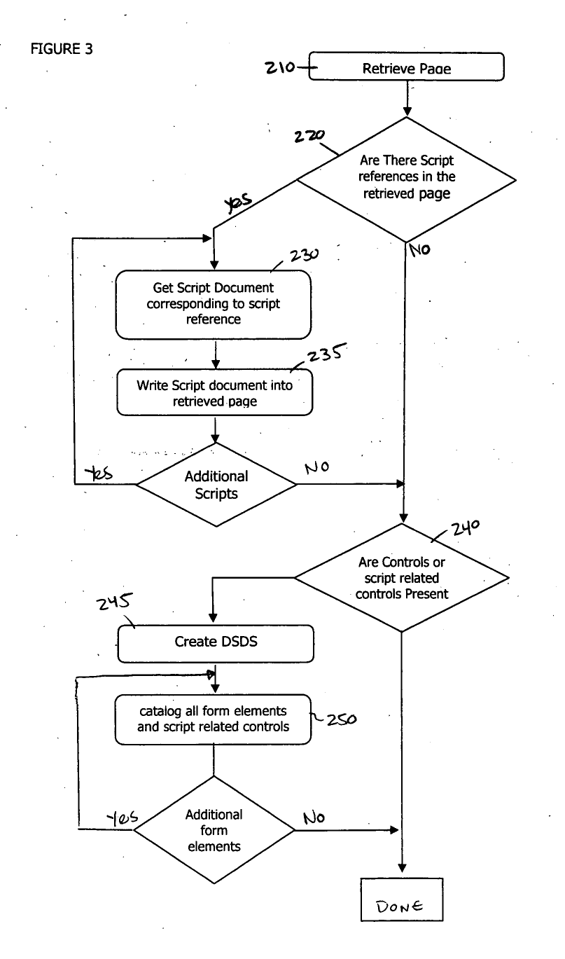

The method may further continue either after the scripted documents are aggregated into the retrieved document or during aggregation with analyzing the retrieved page to determine if any forms (referred herein to “controls”) within the documents invoke script documents or if any script reference code blocks within the retrieve page affect any controls on the web page, FIG. 3, Step 240. Controls are well known and permit the user to select, either in a checkbox, button, or drop-down menu, a choice of a form element, typically but not always from at least two possible form elements. When the form element is selected the web page invokes script documents corresponding to the user's response. When either controls referencing scripts or when scripts reference controls are present in the retrieved page, the method with create a document script definition schema (referred to herein as DSDS), Step 245, and catalog into the DSDS all form elements and all script blocks referencing the form elements, Step 250.

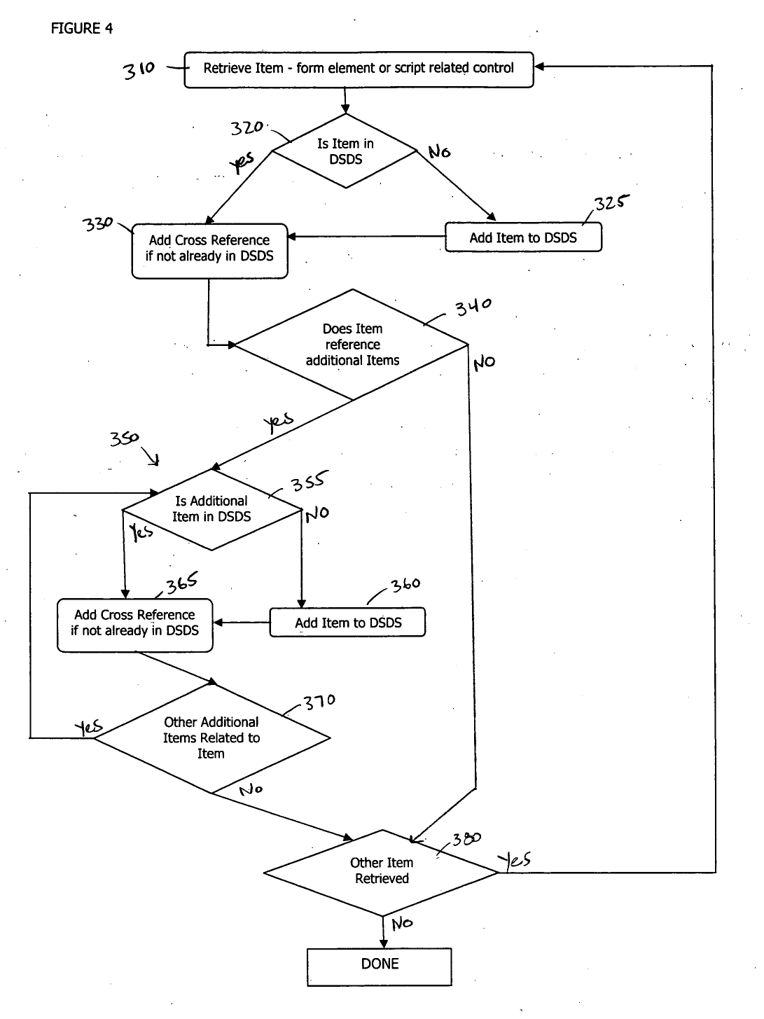

Continuing to FIG. 4, as part of the cataloging, step 250, the method should verify that all form elements and script related controls are cataloged in the DSDS. This should be done prior to processing the DSDS and retrieving all of the documents invoked by selecting the form elements. The verification of the form elements and script related controls is accomplished by analyzing each form element or script block. As the form element or script related control (referred to herein as primary item) is retrieved, Step 310, the primary item is verified to determine whether the primary item has been cataloged in the DSDS, Step 320. If not, the primary item is added to the DSDS, Step 325. The position the primary item holds in the web page is then cross referenced to the primary item and cataloged in the DSDS, Step 330. If the primary item has already been added to the DSDS, the invention will then add appropriate cross-references, Step 330, to the DSDS for the primary item in the position it holds in the web page. If the primary item has additional items (form elements or script related controls) associated to the primary item, Step 340, the invention will add all associated secondary items to the DSDS, Step 350. This is accomplished by first verifying that the secondary item is not already in the DSDS, Step 355. The secondary item is cataloged in the DSDS by relating the secondary item to the corresponding primary item, Step 360 and cataloging the cross reference to the secondary item, Step 365. This is repeated for each secondary item corresponding to a primary item, Step 370. In addition, if the secondary item contains items, these tertiary items are cataloged, and etc. The method will then repeat until all primary items have been cataloged, Step 380.

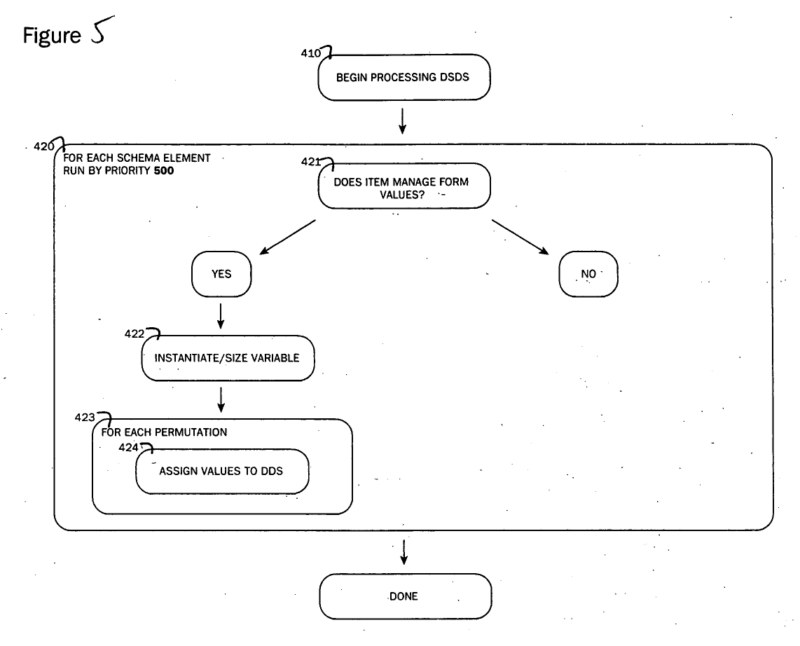

Referring now to FIG. 5, once all items (i.e. form, form elements and script blocks that reference form and form elements) have been cataloged in the DSDS, the invention begins building the data permutation structure for presentment to the web page, Step 410. For each item in DSDS, Step 420, (executed based on the established script priority rules), the invention analyzes the script source to identify the form elements, otherwise known as the variables and values, Step 421. If the item does not contain a value or variable, the item may be a user defined item, such as a request for the user's name or login; these items are not processed. If the item does contain values or variables, the method instantiates, sizes the value or variable, Step 422. The method then builds a document data set (referred to herein as DDS), Step 423, to hold the permutation data. For each permutation the value is assigned to the DDS, Step 424. This is repeated for each permutation and each value or variable.

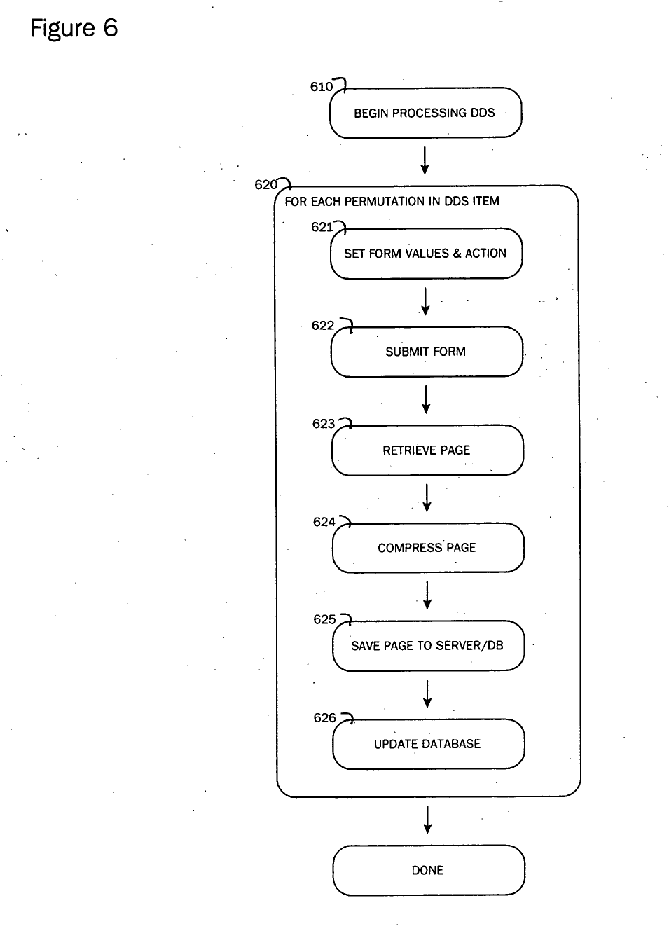

Once all of the values and variables have been fully cataloged in the DDS, the invention will begin the process of retrieving all the permutation pages associated with the form permutations, Step 610 in FIG. 6. For each permutation in the DDS, Step 620, the method will set form variables, values and actions, Step 621. Next the method submits the form, Step 622, with the value set. The web site will return a web page that includes a document specific to the permutation, Step 623. The retrieved or returned page is then reposed, Step 624, and the page is saved to the database 110 or document server 115, Step 625. Finally, the bot database is updated, Step 626.

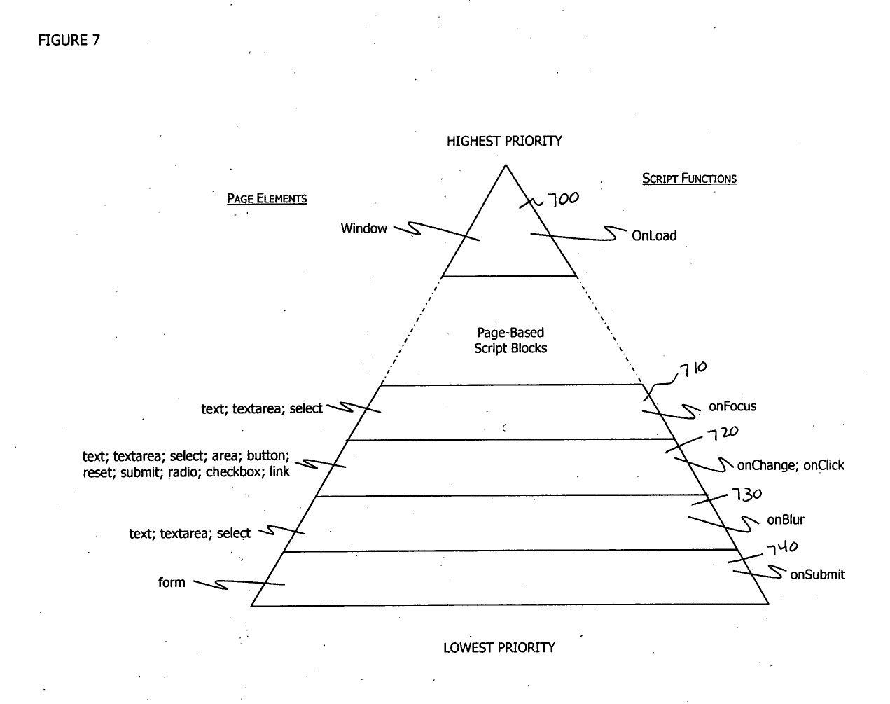

As mentioned above, for each item in DSDS the method will follow established script priority rules. These rules are illustrated in FIG. 7. Both Page Elements and Script Functions follow priority rules. Block 700 illustrates that Window elements and onLoad script functions are the highest priority. Underneath Block 700 are Page-Based Script Blocks. Block 710 dictates that an onFocus script function dealing with text; textarea; or select elements are the highest page-based script blocks. Next in Block 720 is onChange and OnClick script functions which can deal with text; textarea; select; area; button; rest; submit; radio; checkbox; or link page elements. In Block 730, onBlur script functions can deal with text; textarea; or select page elements. Lastly, in Block 740, onSubmit script functions can deal with form page elements.

From the foregoing and as mentioned above, it will be observed that numerous variations and modifications may be effected without departing from the spirit and scope of the novel concept of the invention. It is to be understood that no limitation with respect to the specific embodiments illustrated herein is intended or should be inferred. It is, of course, intended to cover by the appended claims all such modifications as fall within the scope of the claims.

1. A computer implemented method for performing a crawl of a web-page, which is published on a web server, the web-page containing a script reference corresponding to a script document that was previously inaccessible to the crawl, the method comprising:
retrieving said script reference corresponding to said script document; and
retrieving said script document corresponding to said script reference by presenting said script reference to said server.

2. The method of claim 1 further comprising retrieving said web-page and creating an aggregate page that includes the script document.

3. The method of claim 2 further comprising reposing said aggregate page.

4. A computer implemented method for performing a crawl of a web-page that contains a script reference corresponding to a script document, the method comprising:
retrieving said web-page;
retrieving said script reference corresponding to said script document;
retrieving said script document corresponding to said script reference;
creating an aggregate page that includes the web page and the script document; and
reposing said aggregate page.

5. A computer implemented method for performing a crawl of a web-page that contains a form with a form value that when selected by a user will invoke a document related to said form value, the crawler method comprising:
retrieving said form value;
presenting said form value to invoke said document related to said form value; and
retrieving said document.

6. The method of claim 5 further comprising:
reposing said document.

7. The method of claim 5 wherein said document contains a secondary form with a secondary form value that when selected by a user will invoke a secondary document related to said secondary form value, the method further comprising:
retrieving said secondary form value related to said to said secondary form;
presenting said secondary form value to said web-page to invoke said secondary document related to said secondary form value; and
retrieving said secondary document for indexing.

8. A computer implemented method for performing a crawl of a web-page that contains a script related control with a value that when selected by a user will invoke a document related to said value, the crawler method comprising:
retrieving said value;
presenting said value to said web-page to invoke said document related to said value; and
retrieving said document.

9. The method of claim 8, reposing said document.

10. A computer implemented method for performing a crawl of a web-page that contains a form with a plurality of form values that when separately selected by a user will invoke a plurality of documents separately related to said plurality of form values, the crawler method comprising:
retrieving said plurality of form values;
presenting each form value, of the plurality of form values, to said web-page to invoke the plurality of document related to said plurality of form values; and
retrieving said plurality of documents.

11. The method of claim 10 further comprising reposing said plurality of documents.

12. A computer implemented method for performing a crawl of a web-page that contains a form with a form value that when selected by a user will invoke a document related to said form value, wherein said document was inaccessible to the crawl, the crawler method comprising:
retrieving said form value;
submitting said form with said form value to invoke said document related to said form value; and
retrieving said document.

13. The method of claim 12 further comprising reposing said document.
